(19) United States
(12) Patent Application Publication
(10) Pub. No.: US 2026/0004610 A1
(43) Pub. Date: Jan. 1, 2026

(54) PASSIVE ENROLLMENT FOR USER RECOGNITION

(71) Applicant: Microsoft Technology Licensing, LLC, Redmond, WA (US)

(72) Inventors: Gyancarlo GARCIA AVILA, Redmond, WA (US); Wei CHEN, Redmond, WA (US)

(21) Appl. No.: 18/760,498

(22) Filed: Jul. 1, 2024

(51) Int. Cl. G06V 40/16; G06V 10/82; G10L 17/00; H04L 12/18

(52) U.S. Cl. CPC G06V 40/173; G06V 10/82; G10L 17/00; H04L 12/1831

(57) ABSTRACT

Described are techniques for passive user recognition in meeting environments, utilizing advanced biometric data processing. An in-room meeting system with a camera is used to capture meeting participant images. The images are analyzed to detect faces and generate face embeddings—vector representations of faces. These face embeddings are compared against a dynamically generated database of known users, accumulated from previous meetings, to verify participant identities without requiring explicit biometric submissions. This automated process enhances meeting efficiency by streamlining participant verification and improving security.

### TECHNICAL FIELD

The present application pertains to the technical field of biometric enrollment systems within in-room environments. More specifically, it involves passive enrollment techniques for automatically recognizing individuals in a meeting room setting without requiring active participation from the users. The techniques described herein are relevant to enhancing user interaction with in-room systems such as conference room systems, utilizing facial and voice recognition to seamlessly enroll and verify meeting participants, thereby facilitating a more efficient and user-centric meeting experience.

### BACKGROUND

In the realm of business and organizational communication, meetings play a pivotal role in strategy formulation, decision-making, and information dissemination. Traditionally, meetings were confined to physical rooms where meeting participants gathered at a set location. However, with the advent of a variety of different but related digital technologies, the landscape of how meetings are conducted has undergone significant transformation.

The evolution of meeting systems can be broadly categorized into two parallel developments: online meeting systems and advanced in-room meeting systems. While online meetings gained prominence with the rise of the internet and have become indispensable, especially highlighted during global events such as the COVID-19 pandemic, in-room meeting systems have also seen substantial advancements, driven by the need to make physical meetings more productive and engaging. In-room meeting systems, which traditionally included fundamental components such as simple microphones, basic video cameras, and standard speaker setups, are continually evolving to incorporate sophisticated technologies. These ongoing advancements aim to enhance the user experience and bridge the gap between physical and digital meeting spaces.

### BRIEF DESCRIPTION OF THE DRAWINGS

Embodiments of the present invention are illustrated by way of example and not limitation in the figures of the accompanying drawings, in which:

FIG. 1 is a system diagram illustrating the functional components of one example of an in-room network-based meeting system that performs a passive enrollment method, consistent with some embodiments.

FIG. 2 is a diagram illustrating an example of how an in-room meeting system automatically and passively identifies meeting participants and then associates or maps meeting participants to their corresponding identifiers, consistent with embodiments.

FIG. 3 is a flow diagram illustrating an example of operations performed as part of a method for passively enrolling meeting participants, consistent with some embodiments.

FIG. 4 is a block diagram illustrating a software architecture, which can be installed on any of a variety of computing devices to perform methods consistent with those described herein.

FIG. 5 is a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are techniques for the passive enrollment of individuals in meeting environments, particularly focusing on meeting rooms equipped with meeting room systems-sometimes referred to as conference room systems. In some examples, the techniques described herein involve automatically recognizing and verifying meeting participants through a unique clustering algorithm that analyzes facial embeddings (e.g., vector representations of faces) of meeting participants across various meetings, creates clusters of facial embeddings with corresponding candidate meeting participants, and then cross references the facial embeddings with meeting data that includes the identifiers of meeting participants. By employing a process of elimination, the facial embeddings are mapped to or associated with the corresponding identifiers of meeting participants, without requiring any active participation from the users. The following description provides detailed insights into the operation of this clustering algorithm, setting forth specific details to ensure a comprehensive understanding of the various embodiments of the present invention. It should be noted, however, that the present invention may be adapted with various modifications and alterations to the details and features described herein, as would be apparent to one skilled in the art.

In many instances, conferencing or meeting room systems are designed primarily to facilitate both audio and video communications between participants, whether they are present in the room or joining remotely. Despite this capability, these systems often do not actively enroll or record the attendance or presence of individuals at the meeting. While people are invited and attend these meetings, the system itself does not take steps to identify or log the attendance of any specific participant-particularly when meeting in a conference room. This absence of participant enrollment can pose challenges in maintaining accurate records of attendance and contributions during meetings. On the other hand, some systems require explicit actions by users to facilitate user enrollment. These actions typically include presenting a key card, scanning a thumbprint, undergoing an eye scan, or entering a username and password. Such requirements not only introduce friction in the user experience but also slow down the process of meeting initiation, leading to inefficiencies in a professional setting.

The necessity for each participant to take explicit actions for identification can be particularly inconvenient in scenarios where quick or seamless access to meeting rooms and the access and use of meeting room systems are essential. For instance, in high-paced business environments or in situations where participants move between multiple meetings in different locations, the time taken for each authentication act accumulates, leading to significant delays. Moreover, these methods can disrupt the flow of meetings, as participants must often pause to perform these actions upon entering the room.

Furthermore, most conventional meeting room systems that provide some type of enrollment feature mandate that users first provide a sample of the biometric or information used for enrollment. For example, a user may need to initially register by providing a thumbprint, undergoing an eye scan, or having their face scanned. This initial enrollment process can be cumbersome and time-consuming, adding an additional barrier to the swift commencement of meetings. Moreover, the requirement to collect and store personally identifying information such as biometric data or detailed personal credentials poses significant data privacy concerns. The storage of such sensitive information increases the risk of unauthorized access and data breaches, which can lead to severe privacy violations and potential legal repercussions. Furthermore, the management of this data requires robust security measures, which can be costly and complex to implement and maintain.

The collection and storage of personally identifying information pose substantial technical challenges related to data privacy and security. Managing the security of sensitive data such as biometrics or personal credentials involves complex technical measures to prevent unauthorized access and breaches. These challenges are not only about securing the data but also about designing systems that can robustly handle potential security threats without impacting user accessibility and system performance. These technical problems underscore the necessity for an innovative approach to user recognition and authentication in meeting environments.

Described herein is a technical solution to the several aforementioned technical challenges. Specifically, the techniques disclosed herein address the aforementioned technical challenges by providing a system for passive user recognition and authentication in meeting environments. Consistent with some embodiments, the meeting room system will receive and store meeting room data that includes, for example, an identifier of a meeting room to be reserved, a meeting time and duration, identifiers for meeting participants who have been invited to attend the meeting, and information (e.g., meeting identifier, telephone number, etc.) to facilitate a connection to the meeting for remote participants. Then, during a scheduled meeting, one or more cameras integrated with the meeting room system will capture images of the meeting participants, both in the room for those meeting participants who in attendance. These images are processed using various machine learning models, including computer vision models, to first detect the faces of the meeting participants, and then to generate a digital representation of each face. This digital representation of a face is referred to as a face embedding, and is typically derived with a machine learning model referred to as an embedding model. These face embeddings are unique digital representations of each individual's facial characteristics and features. Specifically, each face embedding is a vector representation of a face, and each face embedding is derived so that similar faces will have similar vector representations. This allows for comparing two face embeddings using one of several similarity metrics, to determine if the two face embeddings represent the same person. For example, the distance between two face embeddings of the same person will consistently be close in distance to one another, such that when the distance between any two face embeddings is less than some predetermined threshold, the system assigns the two face embeddings to the same person.

Once the face embeddings are generated for the meeting participants, the face embeddings are compared to existing face embeddings (e.g., a cluster from a prior meeting), in order to determine if any existing (e.g., previously captured and stored) face embeddings are linked or mapped to the identifier of a single meeting participant. Here, an identifier of a meeting participant may be an alias, username, email address, telephone number, or any other unique identifier provided for the meeting participants. Accordingly, if a face embedding of a meeting participant matches a previously stored face embedding that is associated with only one identifier, the system determines that the person associated with that identifier is present for the meeting, and the system can then take various actions to enhance or improve the meeting. For example, the meeting room system will enroll the meeting participant to record his or her presence at the meeting, and possibly obtain profile data of the meeting participant, thereby allowing the meeting participant to query a conversational chat-style agent.

When a face embedding does not match a previously captured and stored face embedding that is linked to a single identifier, the system will use the meeting data—specifically, the identifiers of the meeting participants who have been invited to attend the meeting—and the face embeddings to assess whether the face embedding matches a stored face embedding that is associated with more than one identifier. To refine this process, the system employs a method of analyzing “clusters,” where each cluster comprises a face embedding linked to two or more candidate meeting participants. By examining these clusters in the context of the current meeting's participant identifiers, the system can effectively use a process of elimination to narrow down the possibilities. This method allows the system to progressively isolate and link a face embedding to a single identifier, thereby accurately identifying the individual participant. This targeted approach ensures that each participant's identity is correctly authenticated and linked to their unique profile within the meeting's context, enhancing both security and personalization of the meeting experience.

When the meeting room system cannot match a face embedding with a previously captured face embedding that is linked to a single identifier, the system will store a “cluster.” Specifically, the face embedding will be stored and linked to each potential meeting participant's identifier who was present at the meeting. For example, if a face embedding cannot be definitively matched to any single known participant in a meeting attended by Alice, Bob, and Carol, the system will store this embedding in a cluster linked to Alice, Bob, and Carol's identifiers. These clusters allow for the system's learning and recognition process in subsequent meetings. By maintaining these clusters, the system can utilize them during future meetings to further refine and isolate the identity of participants as more data becomes available. Each time a meeting participant reappears in a meeting, their new face embedding can be compared against existing clusters, allowing the system to gradually reduce the ambiguity of participant identities and enhance the accuracy of its recognition capabilities.

By continuously updating and verifying face embeddings across multiple meetings, attempting to isolate or link face embeddings to a single identifier, the system not only simplifies the authentication process but also enhances the meeting experience. Participants can enter a meeting room and be automatically recognized by the system, which can then personalize the meeting environment according to their preferences and history. For example, the system might automatically load the participant's digital documents, display their upcoming meetings, or adjust the room's settings based on their previous preferences.

After successfully isolating an identifier and matching it to one or more face embeddings associated with the same person, the system may further attempt to validate its findings using voice recognition technology. This additional verification step involves obtaining a voice profile for each verified participant, which functions similarly to a fingerprint but uniquely identifies an individual's voice. During a meeting, the system captures an audio stream and analyzes it using advanced voice recognition algorithms. It compares the detected voices in the audio stream against the stored voice profiles corresponding to the identifiers linked with the face embeddings. If a match is found between the voice in the audio stream and the voice profile associated with the identified face embeddings, this serves as a confirmation of the participant's identity. This method not only reinforces the accuracy of the participant recognition process but also adds an extra layer of security and personalization, ensuring that the system's recognition capabilities are robust and reliable.

Once an identifier is conclusively mapped to the face embeddings of a single person and the voice profile of that individual has been confirmed or verified during a meeting, the system updates a specific indicator, such as a data field, to reflect this verification. This indicator not only confirms the linkage between the face embeddings, voice, and identifier but also records the timestamp of when this confirmation occurred. This process ensures that each participant's data remains current and accurately represented within the system. Periodically, as the participant attends subsequent meetings, the system continues to verify their voice and cross-reference it with new face embeddings captured during these sessions. This ongoing verification process allows the system to continuously update and refine the participant's profile with the most recent biometric data. By maintaining up-to-date and accurate representations of each participant's face embeddings and voice profiles, the system enhances its ability to provide personalized and secure meeting experiences, ensuring that the data remains fresh and representative of the participant's current appearance and voice characteristics.

In some examples, the system is designed with robust security measures to protect the stored face embeddings and associated identifiers. Data encryption and secure access protocols ensure that the biometric data and personal identifiers are protected against unauthorized access and breaches. Furthermore, the system's design minimizes the amount of personally identifiable information stored, thereby reducing the potential for privacy violations. The proposed technical solution leverages advanced biometric processing and machine learning technologies to facilitate a seamless, secure, and personalized meeting experience. By automating the process of user recognition and reducing the reliance on active user input or initial biometric enrollment, the system addresses the technical challenges of operational inefficiencies, user experience disruption, barriers to entry, and data privacy risks. This innovative approach not only enhances the functionality of meeting room systems but also sets a new standard for privacy and efficiency in professional settings. Other aspects and advantages of the various techniques will be readily apparent from the description of the several figures that follows.

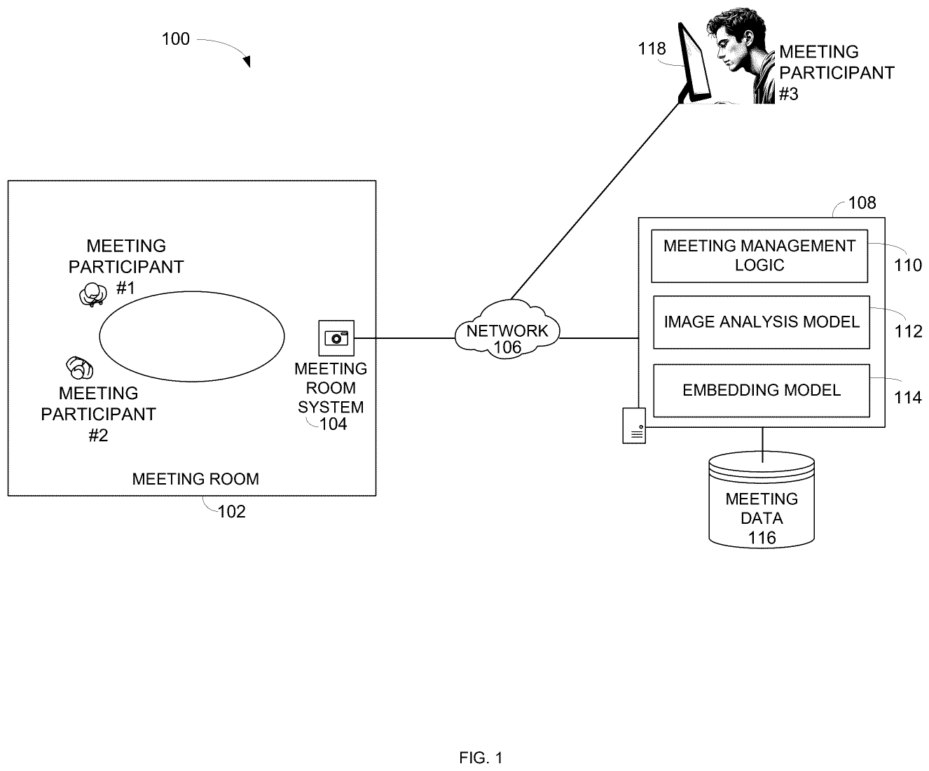

FIG. 1 is a system diagram illustrating the functional components of one example of system 100 that performs a passive enrollment method, consistent with some embodiments. The diagram showcases the overall system 100, which includes an in-room meeting room system 104 situated within the meeting room 102. This meeting room system 104 is connected, via a network 106, to a cloud-based meeting management system 108, which facilitates the orchestration and management of meetings.

The meeting room system 104 is equipped with an integral camera designed to capture images of meeting participants present in the room, during meetings. These images allow for the passive enrollment process, as they are used to identify and authenticate meeting attendees without requiring any active participation from them. Once captured, these images are transmitted over the network 106 to the cloud-based meeting management system 108.

Within the cloud-based meeting management system 108, the images undergo analysis by an image analysis model 112. This model 112 is responsible for detecting faces within the images and extracting data needed to generate unique face embeddings. These embeddings are vector representations of the detected faces, which are then used to identify and verify the meeting participants' identities against a pre-existing database of known users.

The meeting management system 108 also includes meeting management logic 110, which facilitates the scheduling and overall management of meetings. Users interact with this system to schedule their meetings, creating meeting data 116 that includes details such as the meeting time, duration, and the participants' identifiers. This data is stored within the cloud system and is accessible to the meeting room system 104 to ensure all scheduled meetings are adequately supported.

The system diagram also illustrates three meeting participants, labeled as Meeting Participant #1, Meeting Participant #2, and Meeting Participant #3. Notably, Meeting Participant #3 is indicated as a remote participant, highlighting the system's capability to seamlessly integrate both in-room and remote attendees in a single meeting environment. This integration is facilitated by the network 106, which ensures that data and communications flow smoothly between the in-room system 104, the remote participants, and the cloud-based meeting management system 108.

Each component of the system is designed to work in harmony to provide a seamless meeting experience. The in-room meeting room system 104 captures and transmits visual data, the network 106 ensures efficient data transfer, the cloud-based meeting management system 108 processes and analyzes the data, and the meeting management logic 110 oversees the operational aspects of meeting scheduling and management. Together, these components form a comprehensive solution to modern meeting challenges, enhancing efficiency, security, and user satisfaction through innovative passive enrollment techniques.

In this diagram, “FE1” and “FE2” are used to denote different representations of faces, specifically face embeddings, which are unique vector representations derived from images captured during meetings. The identifiers such as “john.doe” and “jane.smith” are examples of unique identifiers associated with these embeddings, linking the biometric data to specific individuals.

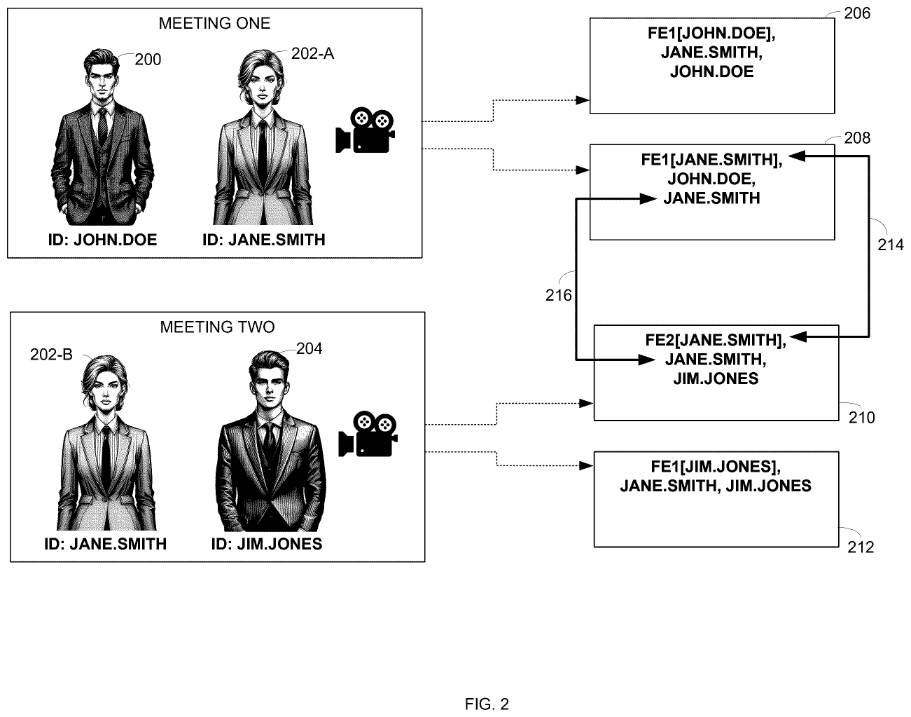

During a first meeting, as illustrated in the segment labeled “Meeting One” in FIG. 2, the system captures images of the participants and generates initial face embeddings. For instance, FE1 [john.doe] and FE1 [jane.smith] represent the face embeddings created from the images of John Doe and Jane Smith, respectively. These embeddings are stored along with their associated identifiers. The system creates clusters of these embeddings, which include data about the meeting and the participants, effectively grouping face embeddings by the meeting context in which they were captured.

In a subsequent meeting, labeled as “Meeting Two” in FIG. 2, the system again captures images and generates new face embeddings. For example, FE2 [jane.smith] represents a new face embedding for Jane Smith, derived from her image captured during the second meeting. The system then compares these new embeddings with those stored from previous meetings. The comparison aims to find matches that confirm the identities of the participants re-attending the meetings.

The diagram specifically points to a decision process at step 216, where the system determines that only one meeting participant, Jane Smith, is shared in common between the meeting data of the first and second meetings. This is indicated by the matching face embeddings FE1 [jane.smith] from the first meeting and FE2 [jane.smith] from the second meeting, as shown at step 214. The match between these embeddings confirms her identity and her presence at both meetings.

This process of generating, storing, and comparing face embeddings across meetings allows the system to passively authenticate meeting participants without requiring any active input from them. It leverages historical data to enhance the accuracy of participant recognition, thereby streamlining the meeting process and enhancing security and user experience.

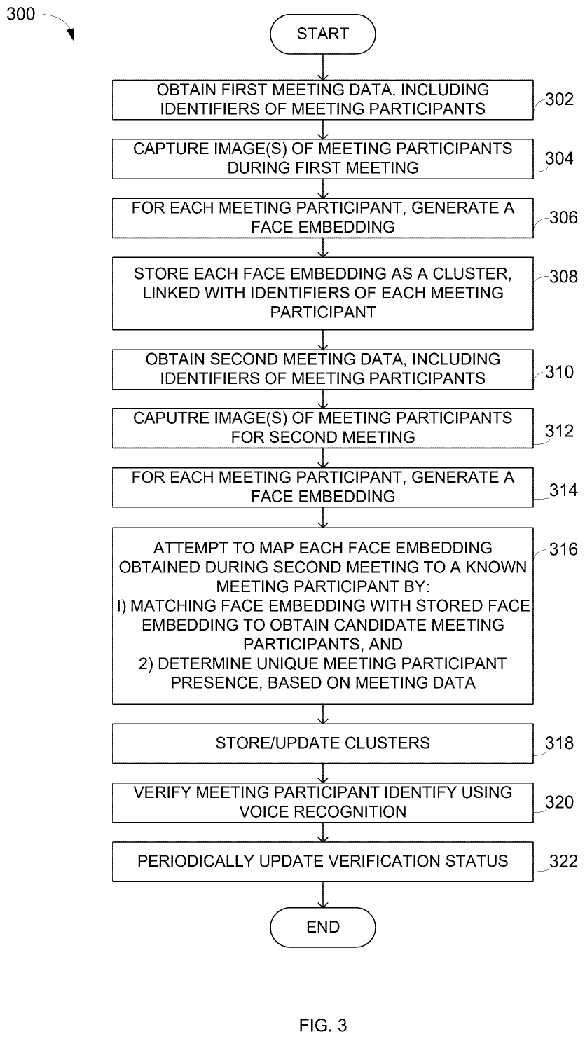

FIG. 3 is a flow diagram illustrating an example of operations performed as part of a method for passively enrolling meeting participants, consistent with some embodiments. The flow diagram of FIG. 3 provides a visual representation of the steps involved in capturing, processing, and utilizing data to recognize individuals in a meeting environment without requiring their active participation. The process begins with the collection of preliminary meeting data and progresses through various stages of image capture, participant recognition, and data linkage. Each step is designed to enhance ability of the system to accurately identify meeting attendees using data analysis and advanced computer vision and machine learning techniques, thereby streamlining the meeting process and improving security and personalization.

At operation 302 of FIG. 3, the system obtains the first meeting data, which sets the context of the first meeting and prepares the system for meeting participant recognition. The meeting data generally includes details about the meeting such as the meeting time, duration, location, and importantly, the identifiers of all persons invited to attend the meeting. These identifiers are used to link the presence of the participants captured through images to their digital profiles within, or accessible to, the system. Identifiers can vary depending on the design, implementation, and organizational protocols of the system. Commonly used identifiers include names, email addresses, employee ID numbers, usernames, telephone numbers, and aliases. This flexibility in the choice of identifiers allows the system to be adapted to different needs and organizational environments.

At operation 304, as the first meeting begins, the in-room meeting system, which integrates one or more cameras, captures images of the meeting participants. The system may capture one image depicting multiple meeting attendees, or several images, with each image depicting an individual meeting attendee. The one or more cameras are strategically positioned and activated to take photographs at specific times, often determined by the meeting schedule set forth in the meeting data obtained previously. In some instances, motion detection may be leveraged, in combination with meeting data, to determine when a meeting is beginning and when the images should be captured. This timing ensures that images are captured when participants are present and engaged. Once the images are taken, computer vision algorithms are employed to detect the depiction of the various meeting attendees within the images. The algorithms facilitate the analysis of the visual data to identify human figures and distinguish individual features—specifically, their faces. The integration of the camera with the meeting system and the use of the meeting time as a trigger for image capture streamline the process, making it both efficient and less intrusive, as the system autonomously knows the optimal moments to activate the camera based on the scheduled meeting times.

In some embodiments, the system's capabilities may be confined to detecting and enrolling only those attendees who are physically present in the meeting room. However, in other embodiments, the system can extend its functionality to include the identification of remote meeting participants. For these remote attendees, the process involves the use of cameras integrated into their remote devices, such as laptops or smartphones. These cameras capture the images of the participants, which are then typically transmitted over a computer network for processing by the central meeting system. This allows the system to apply similar analytical techniques used for in-room participants to those who are joining remotely. The images received from remote participants undergo the same advanced computer vision and machine learning analysis to detect faces and generate corresponding face embeddings. This comprehensive approach ensures that all participants, whether in-room or remote, are seamlessly and accurately enrolled and recognized by the system, enhancing the inclusivity and functionality of the meeting environment.

Consistent with some embodiments, the capabilities of the system may be confined to detecting and enrolling only those attendees who are physically present in the meeting room. However, in other embodiments, the system can extend its functionality to include the identification of remote meeting participants. For these remote attendees, the process involves the use of cameras integrated into their remote devices, such as laptops or smartphones. These cameras capture the images of the participants, which are then typically transmitted over a computer network for processing by the central meeting system. This allows the system to apply similar analytical techniques used for in-room participants to those who are joining remotely. The images received from remote participants undergo the same advanced computer vision and machine learning analysis to detect faces and generate corresponding face embeddings. This comprehensive approach ensures that all participants, whether in-room or remote, are seamlessly and accurately enrolled and recognized by the system, enhancing the inclusivity and functionality of the meeting environment.

At operation 306 of FIG. 3, following the capture of images, the in-room meeting system processes these images to generate face embeddings for each detected meeting participant. This step involves the application of one or more pre-trained machine learning models, specifically designed for facial recognition and the generation of facial embeddings. The model(s) operate by isolating the facial region from the broader image to focus on the unique characteristics of each face. This isolation ensures that the analysis is concentrated on facial features, enhancing the accuracy of the recognition process.

Once the facial region is isolated, a pre-trained embedding model processes this data to generate a face embedding. A face embedding is a vector representation of the face, where each vector is a compact numerical representation capturing the essential features of the face. These embeddings are designed such that similar faces produce similar vector representations. This similarity is quantifiable, typically through distance metrics in the vector space, where smaller distances between vectors indicate greater similarity between the faces they represent.

The generation of face embeddings is a process that leverages deep learning techniques, particularly convolutional neural networks (CNNs), which are adept at handling image data. In some examples, the model used is pre-trained on vast datasets of faces, allowing it to “learn” a wide array of human facial features and variations. This training enables the model to produce highly discriminative embeddings for each face, facilitating reliable and accurate meeting participant recognition in subsequent steps of the operation of the system. The robustness of face embeddings lies in their ability to handle variations in facial expression, orientation, and lighting, making them exceptionally suited for dynamic meeting environments where such changes are commonplace.

From a data privacy perspective, the use of face embeddings offers significant advantages. Unlike storing raw images, which can contain a wealth of personal information and are susceptible to misuse, the system only retains these images temporarily to extract the necessary data. Once the face embeddings are generated, the original images are deleted from the system. This approach minimizes the risk of personal data exposure and reduces the storage requirements. The face embeddings, which are essentially numerical representations derived from the images, capture the essential features needed for participant recognition without retaining the detailed visual characteristics of an individual's face. This digital representation significantly enhances privacy as it is difficult to reverse-engineer the original image from the embeddings. Consequently, only these embeddings are stored long-term by the system. This method of handling data not only ensures compliance with stringent privacy regulations but also builds trust among users by prioritizing the protection of their personal information in the meeting environment.

Consistent with some embodiments, the processing of images to generate face embeddings occurs directly on a computing device that is part of the in-room meeting system located within the meeting environment. This local processing approach leverages the computational power of in-room devices, such as integrated meeting room systems or dedicated processing units. By handling image processing and face embedding generation on-site, the system can potentially offer faster response times and enhanced data security, as sensitive visual data does not need to be transmitted over external networks.

Conversely, in other embodiments, the images captured by the in-room meeting system may be transmitted to a remote server for processing, typically in a cloud-based deployment. In this scenario, after images are captured, they are securely communicated over a network to a server located off-site, where powerful cloud-based computing resources process the images to generate face embeddings. This cloud-based approach can provide several advantages, including access to more advanced processing capabilities, improved scalability, and the ability to leverage continually updated machine learning models hosted in the cloud. Additionally, cloud servers can manage data from multiple meeting locations, allowing for centralized data analysis and management.

Both local and cloud-based processing methods are designed to ensure that the system remains efficient and secure, with the choice between them often depending on specific organizational needs, such as the availability of local processing power, concerns about data privacy, and the desired scalability of the system. Each method adheres to the goal of accurately generating face embeddings to facilitate reliable participant recognition within the meeting environment.

At operation 308 of FIG. 3, once the face embeddings have been generated, the system proceeds to store these embeddings in a structured format known as a “cluster.” In the context of the system, a cluster refers to a collection of face embeddings that are linked to the identifiers of meeting participants who were invited to a meeting when the embeddings were captured. This clustering is particularly important when the system is first initialized and lacks historical data on prior meetings.

When the system is initially set up, there are no clusters, and no pre-existing data or face embeddings from previous meetings to compare against. Therefore, the system begins by creating new clusters for each face embedding generated during the first meeting. Each cluster is essentially a data structure that stores the face embedding of a meeting attendee along with associated meeting participant identifiers. For example, if a meeting involves three participants—Alice, Bob, and Carol—the system captures their images and generates corresponding face embeddings. These embeddings are then stored in individual clusters, each cluster including a face embedding of a meeting participant linked to the identifiers of Alice, Bob, and Carol. Accordingly, given a very first meeting and three meeting participants, three clusters would be created, one for Alice, one for Bob and one for Carol. The cluster for the face embedding associated with Alice would be linked to the identifiers of all meeting invitees-Alice, Bob, and Carol-indicating that for each face embedding, one of the three identifiers is the correct identifier.

This initial clustering serves as the foundational data layer upon which the system builds its recognition capabilities. Over time, as more meetings occur and more face embeddings are generated, the system can begin to compare new face embeddings with those stored in existing clusters. This comparison helps in refining the accuracy of meeting participant recognition, as the system learns to associate specific face embeddings more reliably with individual identifiers. The ongoing process of updating and refining clusters with new data exemplifies how the system evolves and improves its functionality through continuous operation and data accumulation.

At method operation 310 in FIG. 3, the system engages in the process of obtaining meeting data for a subsequent meeting, referred to here as the “second meeting.” During this step, the system obtains the meeting data for the second meeting, which includes the identifiers of all meeting participants who have been invited. These identifiers are used to link the physical attendees of the meeting with their digital profiles or records within the system, and within various external syst. Identifiers could include a range of data points such as names, email addresses, employee IDs, or any unique identifiers used within the organization to distinguish individuals.

The purpose of gathering this data is to equip the system with the necessary context for the upcoming meeting. By knowing who is expected to attend, the system can better manage and prepare the face recognition processes that will occur during the meeting. For instance, when participants enter the meeting room and their images are captured, the system can immediately begin to match the new face embeddings with face embeddings that are in clusters linked to the identifiers of meeting participants who have been invited to attend the current (e.g., the second) meeting.

During the second meeting, method operation 312 of FIG. 3 is executed, where the system captures one or more images of the meeting participants. Just as with method operation 304, the system may utilize a single camera to take a comprehensive wide-angle shot that includes all participants, or it may employ multiple cameras to capture individual or group images, depending on the setup and requirements of the meeting room.

At method operation 314 in FIG. 3, following the capture of images for the meeting participants during the second meeting, the system processes each image to generate face embeddings for each participant present. This operation is a continuation of the participant recognition process, where the newly captured images are analyzed to extract and update the facial data of the attendees. During this phase, the system utilizes advanced computer vision techniques to detect and isolate faces within the images. Each detected face is then processed using a pre-trained machine learning model, similar to the one used in previous meetings. These embeddings are designed to ensure that similar facial features result in similar vector outputs, which is advantageous for accurate identification and comparison.

At method operation 316 in FIG. 3, the system undertakes a step by attempting to map each newly generated face embedding from the second meeting to known meeting participants. This operation involves a comparison between the current face embeddings and the clusters of embeddings stored from previous meetings. The goal is to accurately identify each meeting participant by linking their current face embedding with a unique identifier.

The process at operation 316 utilizes both the newly generated face embeddings and the meeting data, which includes identifiers such as names, email addresses, or employee IDs of the participants invited to the second meeting. The system compares each new face embedding against the clusters of embeddings from prior meetings. These clusters represent aggregated facial data linked to specific participant identifiers, capturing variations in each participant's appearance over multiple meetings. For a successful mapping of an individual identifier to the face embeddings of one person, two key requirements must be satisfied: The face embedding from the current meeting must closely match at least one embedding within a cluster from previous meetings. This match is typically quantified using similarity metrics in the embedding space, such as cosine similarity or Euclidean distance. The similarity score must exceed a predefined threshold to be considered a valid match, indicating that the embeddings represent the same individual. In addition, the identifier for the participant must be the only common link between the meeting data of the current meeting and the historical data within the matched cluster. This means that the participant's identifier should uniquely identify them across different meetings without ambiguity. If multiple potential matches exist (i.e., the same face embedding could link to multiple identifiers due to similar appearances or data errors), further verification processes might be necessary to isolate the correct identifier.

By satisfying these requirements, the system can confidently associate a specific face embedding with the correct participant identifier, enhancing the accuracy of participant recognition and personalization of the meeting experience. This operation allows for maintaining the integrity and utility of the system in dynamic and recurring meeting environments.

In a practical application of method operation 316, consider a scenario where three participants—Alice, Bob, and Carol—attend a first meeting, and their face embeddings are generated and stored in respective clusters linked to each of the three meeting participnants' unique identifiers. In a subsequent second meeting, only Bob and a new participant, Dave, are invited and attend. The system captures images from this second meeting, generates new face embeddings for Bob and Dave, and initiates the comparison process with the stored clusters from the first meeting.

The system compares Bob's new face embedding from the second meeting against the clusters from the first meeting using similarity metrics to identify matches. It specifically looks for a high-quality match between Bob's new and previous face embeddings. To ensure the accuracy of this match, the system verifies that Bob's identifier is the sole common element between the participant lists of the two meetings, confirming his presence at the two meetings. This verification process isolates Bob's identifier and the system then links it to his updated face embedding, effectively maintaining a consistent and accurate record of his participation across the two meetings.

For Dave, who is newly introduced in the second meeting, the system lacks prior face embeddings. Consequently, his face embedding from the second meeting is stored as a new cluster linked to his identifier. This cluster will serve as a foundational data point for any future meetings Dave attends, enabling the system to begin tracking and recognizing him in a manner similar to Bob.

This example underscores the capability to utilize both current and historical face embeddings in conjunction with meeting data to accurately identify and verify meeting participants. This method is particularly effective in environments where participant consistency and security are paramount, ensuring that each participant's identity is correctly authenticated and maintained across multiple meetings.

In the described system, the sequence of operations involving the matching of facial embeddings and the determination of participant uniqueness—identifying which participants attended both meetings—can occur in either order, depending on the specific circumstances and data available at the time of processing.

For instance, if the system identifies that only one meeting participant, say Bob, has been invited to two separate meetings, it may initially focus on matching the facial embeddings for these specific meetings where Bob is known to be a participant. This targeted approach allows the system to efficiently utilize the clusters of face embeddings that pertain only to the meetings Bob attended, streamlining the matching process.

In this scenario, the system might first perform a match of the facial embeddings from the two meetings. By comparing Bob's face embeddings from both meetings, the system can quickly establish a preliminary match based on the visual data. Following this, the system would then verify the uniqueness of the participant—confirming that Bob is indeed the participant who attended both meetings. This verification is crucial for ensuring that the matched face embeddings accurately represent the same individual across different sessions.

Alternatively, the system could start by determining the uniqueness of the meeting participants. This would involve analyzing the meeting data to confirm that Bob is the only participant common to both meetings. With this knowledge, the system could then proceed to specifically match Bob's facial embeddings from the clusters associated with these meetings.

At method operation 318 in FIG. 3, the system finalizes the analysis of the second meeting by potentially generating additional clusters and updating existing ones based on the results of the analysis conducted in previous operations. This step is crucial for maintaining the accuracy and relevance of the data stored within the system.

When the system successfully isolates and maps the identifier of a meeting participant to his or her face embedding, it may necessitate updates to the clusters where that participant's identifier appears as a candidate. These updates ensure that the clusters accurately reflect the most current understanding of which face embeddings correspond to which participants.

Consider a scenario where a cluster initially contains face embeddings linked to Alice, Bob, and Carol. This cluster represents a situation where the system previously could not definitively assign the face embeddings to a single individual and thus linked the embeddings to all three participants as potential matches.

During the second meeting, the system captures new images and generates updated face embeddings for Bob. Through the analysis process, the system successfully matches these new embeddings with those stored in the cluster and can confidently isolate Bob's identifier as the correct match for these embeddings. This successful mapping allows the system to update the cluster by removing Bob from the list of candidate meeting participants for the other face embeddings in the cluster.
Identification and Matching: The system identifies Bob's new face embeddings and matches them with existing embeddings in the cluster.
Verification of Uniqueness: The system verifies that Bob is the unique participant matching the embeddings based on the analysis of meeting data and the similarity scores between embeddings.
Cluster Modification: Upon confirming the match, the system updates the cluster by removing Bob's identifier from the candidate list associated with the other embeddings in the cluster. This update reflects the newfound certainty that these other embeddings do not belong to Bob.
Cluster Storage: The updated cluster, now with Bob's identifier removed from certain embeddings, is stored back into the system. This ensures that future analyses will operate with the most accurate and up-to-date information.

This example illustrates how method operation 318 plays a role in refining the data within the system, ensuring that each participant's face embeddings are accurately linked to their identifier. By continuously updating clusters based on new information and confirmed matches, the system enhances its ability to provide precise and reliable participant recognition in future meetings.

At method operation 320 in FIG. 3, the system initiates a verification process using voice recognition to further confirm the identity of a meeting participant, following the successful mapping of their identifier to their facial embeddings. This additional layer of biometric verification significantly enhances the security and accuracy of participant identification.

Once the system has successfully mapped a participant's identifier to their facial embeddings, it retrieves their stored voice profile using the meeting identifier associated with that participant. This voice profile contains unique characteristics and patterns of the participant's voice, which have been previously captured and analyzed to create a distinctive voice signature. During the meeting, the system continuously captures the audio stream, which includes all vocal interactions within the meeting space. This stream is analyzed in real-time to detect and isolate individual voices.

The system then compares the detected voices from the audio stream against the retrieved voice profile of the identified participant. Advanced voice recognition algorithms assess the similarity between the voice characteristics in the audio stream and those in the voice profile, focusing on various acoustic features such as pitch, tone, modulation, and speech patterns. If the voice detected in the audio stream matches the voice profile associated with the participant's identifier, the system confirms the identity of the participant. This confirmation acts as a reinforcement of the initial recognition based on facial embeddings, providing a robust verification that the participant present in the meeting is indeed the individual associated with the identifier.

Consider an example where the system has mapped the identifier of a participant, Bob, to his facial embeddings during a meeting. The system retrieves Bob's voice profile, which includes unique characteristics of his voice previously captured during past meetings. As the meeting progresses, Bob speaks, and his voice is captured in the audio stream. The system analyzes this stream, detects Bob's voice, and compares it against his voice profile. Upon finding a match, the system confirms Bob's identity, reinforcing the facial recognition with voice verification.

This dual-modality approach of using both facial and voice recognition ensures a higher level of security and accuracy in participant identification. By integrating voice verification at method operation 320, the system not only confirms the identity of participants more reliably but also enhances the overall trustworthiness of the recognition process in diverse meeting environments.

At method operation 322 in FIG. 3, the system implements a procedure to periodically verify the identity of meeting participants using voice recognition, which is essential for ensuring that the mappings of facial embeddings to identifiers remain accurate over time. This periodic verification is crucial for adapting to any changes in a participant's voice or appearance, such as those caused by aging, health conditions, or environmental factors.

The system schedules regular voice verification sessions based on predefined criteria, such as the frequency of meetings attended by the participant or any significant changes detected in their facial embeddings. This scheduling ensures that the participant's voice profile is consistently updated and accurately reflects their current voice characteristics. During each scheduled voice verification session, the system captures the participant's voice as part of the meeting's audio stream. It then compares this newly captured voice data against the existing voice profile stored for the participant. If discrepancies or significant variations are detected, the system may prompt for additional verification steps or update the voice profile to reflect the new data.

To maintain a reliable record of the verification status, the system links each facial embedding with the corresponding participant identifier and includes a confirmation indicator. This indicator is updated each time the voice verification confirms the identity of the participant. It serves as a dynamic record, showing not only that the facial embedding has been mapped to the identifier but also that this mapping has been repeatedly validated through voice recognition. By periodically verifying the voice and updating the voice profiles, the system enhances the security and accuracy of participant identification. This ongoing process helps in mitigating risks associated with voice spoofing or impersonation and ensures that the system's recognition capabilities remain robust against various types of fraud.

Consider an example where the system has confirmed Bob's identity in several meetings through both facial and voice recognition. As part of the periodic verification process, in a subsequent meeting, the system again captures Bob's voice and compares it with his stored voice profile. The match confirms Bob's presence and identity, and the system updates the confirmation indicator linked to Bob's facial embedding and identifier. This updated record now reflects the latest verification, providing a trail of authentication that enhances trust in the system's recognition accuracy.

This method of periodic verification and record-keeping ensures that the system remains adaptive and responsive to changes, maintaining high standards of security and participant authentication in a dynamic meeting environment.

In alternative embodiments of the present invention, the system may employ a simplified clustering approach to streamline the process of participant recognition in meeting environments. Instead of generating multiple clusters, each containing a single face embedding linked with candidate identifiers for possible meeting participants, the system may generate a single cluster that encompasses all face embeddings and all identifiers for those meeting participants who have not yet been uniquely identified by mapping a face embedding to a single identifier.

This single cluster approach consolidates all the face embeddings captured during a meeting into one comprehensive cluster. This cluster also includes the identifiers of all participants who were invited to the meeting but have not yet been definitively linked to a specific face embedding. By aggregating all embeddings and identifiers into a single cluster, the system simplifies the initial data structure, potentially reducing the computational overhead associated with managing multiple clusters.

The analysis process in this alternative embodiment involves comparing each new face embedding generated during subsequent meetings against this single, comprehensive cluster. The system assesses whether any of the new embeddings match those stored within the cluster using similarity metrics. If a match is found, the system then examines the identifiers associated with the matched face embedding within the cluster. If the identifier of a participant in the current meeting is the only one linked with the matched embedding, the system can confidently link this identifier to the new face embedding, thereby uniquely identifying the participant.

However, if multiple identifiers are associated with a matched face embedding, the system may employ additional criteria or data, such as the participant's historical attendance or their scheduled presence in the meeting, to further refine and possibly isolate the correct identifier. This process iteratively reduces the ambiguity of participant identification, enhancing the accuracy over time as more data is accumulated and analyzed.

This single cluster method may differ in analysis as it focuses on iteratively refining a larger, more comprehensive dataset, rather than managing multiple smaller clusters. This approach might streamline operations but could require more sophisticated algorithms to effectively parse and refine the data due to the increased complexity of a single large cluster. Additionally, this method emphasizes the importance of robust initial face detection and embedding generation processes, as the integrity of the entire system's recognition capabilities hinges on the quality and accuracy of the data captured in these early stages.

### Machine and Software Architecture

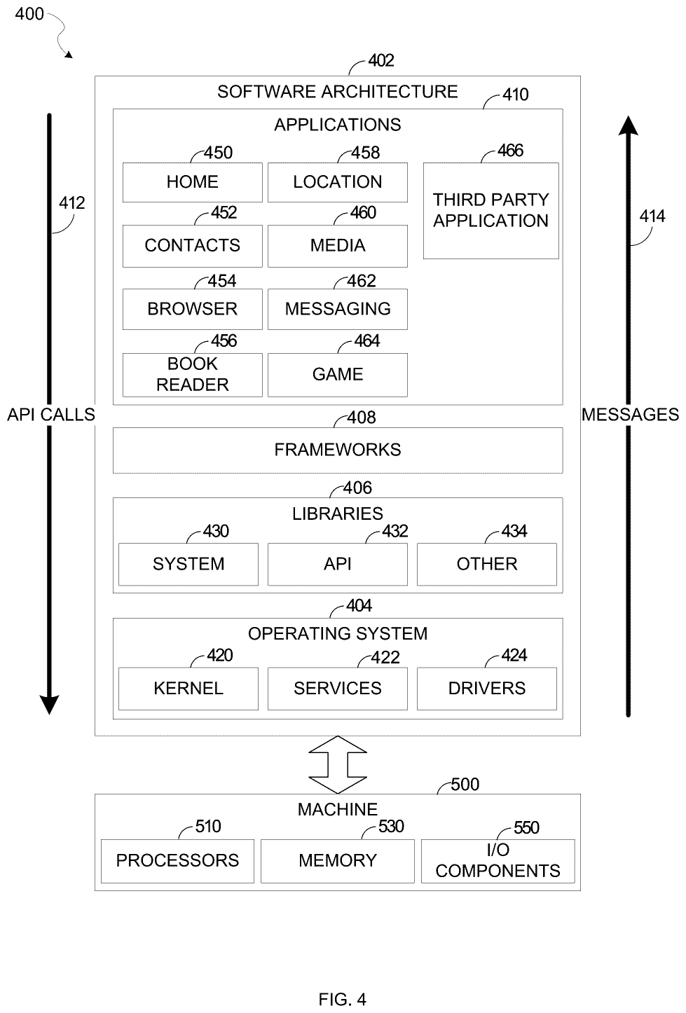

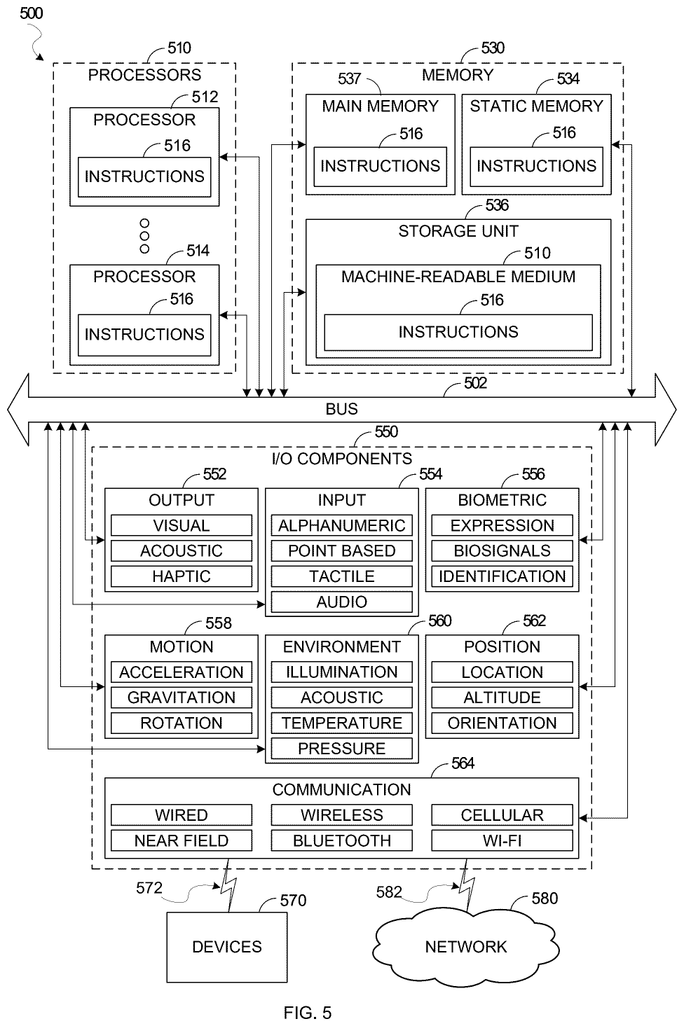

FIG. 4 is a block diagram 400 illustrating a software architecture 402, which can be installed on any of a variety of computing devices to perform methods consistent with those described herein. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 can be conceptualized as a stack of layers where each layer may provide a particular functionality. For example, the software architecture 502 includes layers such as an operating system 404, libraries 406, frameworks 408, and applications 410. Operationally, the applications 410 invoke API calls 412 through the software stack and receive messages 414 in response to the API calls 412, consistent with some embodiments.

In various embodiments, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionality. The services 422 can provide other common services for the other software layers. The drivers 424 are responsible for controlling or interfacing with the underlying hardware, according to some embodiments. For instance, the drivers 424 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410, according to some embodiments. For example, the frameworks 408 provide various GUI functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. According to some embodiments, the applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine to perform any one or more of the methodologies discussed herein, according to an example embodiment. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example the instructions 516 may cause the machine 500 to execute any one of the methods or algorithmic techniques described herein. Additionally, or alternatively, the instructions 516 may implement any one of the systems described herein. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory 530 may include a main memory 532, a static memory 534, and a storage unit 536, all accessible to the processors 510 such as via the bus 502. The main memory 530, the static memory 534, and storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile devices will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or another suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 530, 532, 534, and/or memory of the processor(s) 510) and/or storage unit 536 may store one or more sets of instructions and data structures (e.g., software) embodying or utilized by any one or more of the methodologies or functions described herein. These instructions (e.g., the instructions 516), when executed by processor(s) 510, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 580 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

We claim:

1. A method for user recognition without active enrollment, the method comprising:
for each meeting participant for a first meeting:
capturing with a camera an image of the meeting participant; and
transforming the image of the meeting participant to a representation of a face of the meeting participant;
generating a first set of clusters based on data of the first meeting, each cluster comprising;
a representation of the face of a meeting participant that has not yet been uniquely associated with an identifier; and
an identifier for each meeting participant of the meeting participants that have not yet been uniquely associated with identifiers;
for each meeting participant for a second meeting:
capturing with a camera an image of the meeting participant; and
transforming the image of the meeting participant to a representation of a face of the meeting participant;
generating a second set of clusters for the second meeting, each cluster comprising:
a representation of the face of a meeting participant that has not yet been uniquely associated with an identifier; and
an identifier for each meeting participant of the meeting participants that have not yet been uniquely associated with identifiers;
comparing the first set of clusters with the second set of clusters by:
(a) determining (a1) that a specific identifier is the only identifier of a meeting participant common to both the first meeting and the second meeting, and (a2) that a representation of a face in a cluster from the first set of clusters matches a representation of a face in a cluster from the second set of clusters; or
(b) determining (b1) that a specific identifier is the only identifier in a cluster in the second set of clusters that is not in a cluster in the first set of clusters, and (b2) that only one representation of a face from a cluster in the second set of clusters does not match any representations of faces in any clusters in the first set of clusters; and
according to a result of the comparing, associating the specific identifier of the meeting participant with the representation of the face determined in (a2) or (b2).

2. The method of claim 1, further comprising:
after associating the specific identifier of the meeting participant with the representation of the face according to a result of the comparing, updating the cluster by removing from the cluster identifiers of meeting participants not associated with the representation of the face for the cluster; and
determining that the updated cluster includes only one identifier, thereby confirming that the representation of the face in the updated cluster is uniquely associated with a person corresponding to that identifier.

3. The method of claim 1, further comprising:
before generating the first set of clusters and the second set of clusters, performing an operation to determine whether any identifiers of meeting participants are currently associated with representations of faces for known persons by checking for clusters having one or more confirmed face representations linked to a single identifier of a meeting participant;
excluding from the clusters in both the first set of clusters and the second set of clusters the identifier and representation of a face for any known person.

4. The method of claim 1, wherein comparing the first set of clusters with the second set of clusters includes:
deriving face embeddings from the representations of faces using a pre-trained machine learning model; and
determining a match between two face embeddings by calculating a similarity measure between the face embeddings, wherein a match is determined when the similarity measure exceeds a predefined threshold, indicating that the face embeddings correspond to the same person.

5. The method of claim 1, wherein the representations of faces are face embeddings generated using a convolutional neural network (CNN) that processes the images captured by the camera.

6. The method of claim 1, further comprising:
using an identifier of a meeting participant to retrieve a cluster from a prior meeting that includes the identifier; and
applying a logic rule to determine if a representation of a face from the retrieved cluster for the prior meeting matches a representation of a face from a current meeting, thereby confirming the identity of the meeting participant if a match is found.

7. The method of claim 1, further comprising:
after updating one or more clusters in the first set of clusters or one or more clusters in the second set of clusters by removing an identifier of a meeting participant from a cluster when the identifier is not associated with a representation of the face for the cluster, determining that the updated cluster includes one or more face representations linked to a single identifier;
after determining that the updated cluster includes one or more face representations linked to a single identifier, performing voice recognition on an audio stream of the meeting to verify the attendance of the meeting participant by:
accessing a voice profile associated with the identifier of the meeting participant;
comparing a detected voice in the audio stream with the accessed voice profile to confirm a match; and
upon confirming the match, updating the cluster to include a confirmation indicator verifying the association of the representations of the face with the identifier.

8. The method of claim 6, further comprising:
applying voice recognition, according to a predefined schedule, in one or more subsequent meetings to continuously update the clusters with linked confirmation indicators, confirming that a meeting participant has been verified by voice recognition in these subsequent meetings.

9. A system for user recognition without active enrollment, the system comprising:
at least one processor; and
at least one memory storage device storing instruction thereon, which, when executed by the at least one processor, cause the system to perform operations comprising:
for each meeting participant for a first meeting:
capturing with a camera an image of the meeting participant; and
transforming the image of the meeting participant to a representation of a face of the meeting participant;
generating a first set of clusters based on data of the first meeting, each cluster comprising:
a representation of the face of a meeting participant that has not yet been uniquely associated with an identifier; and
an identifier for each meeting participant of the meeting participants that have not yet been uniquely associated with identifiers;
for each meeting participant for a second meeting:
capturing with a camera an image of the meeting participant; and
transforming the image of the meeting participant to a representation of a face of the meeting participant;
generating a second set of clusters for the second meeting, each cluster comprising:
a representation of the face of a meeting participant that has not yet been uniquely associated with an identifier; and
an identifier for each meeting participant of the meeting participants that have not yet been uniquely associated with identifiers;
comparing the first set of clusters with the second set of clusters by:
(a) determining (a1) that a specific identifier is the only identifier of a meeting participant common to both the first meeting and the second meeting, and (a2) that a representation of a face in a cluster from the first set of clusters matches a representation of a face in a cluster from the second set of clusters; or
(b) determining (b1) that a specific identifier is the only identifier in a cluster in the second set of clusters that is not in a cluster in the first set of clusters, and (b2) that only one representation of a face from a cluster in the second set of clusters does not match any representations of faces in any clusters in the first set of clusters; and
according to a result of the comparing, associating the specific identifier of the meeting participant with the representation of the face determined in (a2) or (b2).

10. The system of claim 9, wherein the operations further comprise:
after associating the specific identifier of the meeting participant with the representation of the face according to a result of the comparing, updating the cluster by removing from the cluster identifiers of meeting participants not associated with the representation of the face for the cluster; and
determining that the updated cluster includes only one identifier, thereby confirming that the representation of the face in the updated cluster is uniquely associated with a person corresponding to that identifier.

11. The system of claim 9, wherein the operations further comprise:
before generating the first set of clusters and the second set of clusters, performing an operation to determine whether any identifiers of meeting participants are currently associated with representations of faces for known persons by checking for clusters having one or more confirmed face representations linked to a single identifier of a meeting participant;
excluding from the clusters in both the first set of clusters and the second set of clusters the identifier and representation of a face for any known person.

12. The system of claim 9, wherein comparing the first set of clusters with the second set of clusters includes:
deriving face embeddings from the representations of faces using a pre-trained machine learning model; and
determining a match between two face embeddings by calculating a similarity measure between the face embeddings, wherein a match is determined when the similarity measure exceeds a predefined threshold, indicating that the face embeddings correspond to the same person.

13. The system of claim 9, wherein the representations of faces are face embeddings generated using a convolutional neural network (CNN) that processes the images captured by the camera.

14. The system of claim 9, wherein the operations further comprise:
using an identifier of a meeting participant to retrieve a cluster from a prior meeting that includes the identifier; and
applying a logic rule to determine if a representation of a face from the retrieved cluster for the prior meeting matches a representation of a face from a current meeting, thereby confirming the identity of the meeting participant if a match is found.

15. The system of claim 9, wherein the operations further comprise:
after updating one or more clusters in the first set of clusters or one or more clusters in the second set of clusters by removing an identifier of a meeting participant from a cluster when the identifier is not associated with a representation of the face for the cluster, determining that the updated cluster includes one or more face representations linked to a single identifier;
after determining that the updated cluster includes one or more face representations linked to a single identifier, performing voice recognition on an audio stream of the meeting to verify the attendance of the meeting participant by:
accessing a voice profile associated with the identifier of the meeting participant;
comparing a detected voice in the audio stream with the accessed voice profile to confirm a match; and
upon confirming the match, updating the cluster to include a confirmation indicator verifying the association of the representations of the face with the identifier.

16. The system of claim 15, wherein the operations further comprise:
applying voice recognition, according to a predefined schedule, in one or more subsequent meetings to continuously update the clusters with linked confirmation indicators, confirming that a meeting participant has been verified by voice recognition in these subsequent meetings.

17. A system for user recognition without active enrollment, the system comprising:
for each meeting participant for a first meeting:
means for capturing with a camera an image of the meeting participant; and
means for transforming the image of the meeting participant to a representation of a face of the meeting participant;
means for generating a first set of clusters based on data of the first meeting, each cluster comprising:
a representation of the face of a meeting participant that has not yet been uniquely associated with an identifier; and
an identifier for each meeting participant of the meeting participants that have not yet been uniquely associated with identifiers;
for each meeting participant for a second meeting:
means for capturing with a camera an image of the meeting participant; and
means for transforming the image of the meeting participant to a representation of a face of the meeting participant;
means for generating a second set of clusters for the second meeting, each cluster comprising:
a representation of the face of a meeting participant that has not yet been uniquely associated with an identifier; and
an identifier for each meeting participant of the meeting participants that have not yet been uniquely associated with identifiers;
means for comparing the first set of clusters with the second set of clusters by:
(a) determining (a1) that a specific identifier is the only identifier of a meeting participant common to both the first meeting and the second meeting, and (a2) that a representation of a face in a cluster from the first set of clusters matches a representation of a face in a cluster from the second set of clusters; or
(b) determining (b1) that a specific identifier is the only identifier in a cluster in the second set of clusters that is not in a cluster in the first set of clusters, and (b2) that only one representation of a face from a cluster in the second set of clusters does not match any representations of faces in any clusters in the first set of clusters; and
according to a result of the comparing, means for associating the specific identifier of the meeting participant with the representation of the face determined in (a2) or (b2).

18. The system of claim 17, further comprising:
after associating the specific identifier of the meeting participant with the representation of the face according to a result of the comparing, means for updating the cluster by removing from the cluster identifiers of meeting participants not associated with the representation of the face for the cluster; and
means for determining that the updated cluster includes only one identifier, thereby confirming that the representation of the face in the updated cluster is uniquely associated with a person corresponding to that identifier.

19. The system of claim 17, further comprising:
before generating the first set of clusters and the second set of clusters, means for performing an operation to determine whether any identifiers of meeting participants are currently associated with representations of faces for known persons by checking for clusters having one or more confirmed face representations linked to a single identifier of a meeting participant;
means for excluding from the clusters in both the first set of clusters and the second set of clusters the identifier and representation of a face for any known person.

20. The system of claim 17, wherein the means for comparing the first set of clusters with the second set of clusters includes:
means for deriving face embeddings from the representations of faces using a pre-trained machine learning model; and
means for determining a match between two face embeddings by calculating a similarity measure between the face embeddings, wherein a match is determined when the similarity measure exceeds a predefined threshold, indicating that the face embeddings correspond to the same person.
